(19) United States
(12) Patent Application Publication
(10) Pub. No.: US 2011/0034064 A1
(43) Pub. Date: Feb. 10, 2011

(54) RECEPTACLE CONNECTOR

(75) Inventor: ZHENG-HENG SUN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/551,462

(22) Filed: Aug. 31, 2009

(30) Foreign Application Priority Data
Aug. 7, 2009 (CN) 200910305360.1

(51) Int. Cl. H01R 13/62

(52) U.S. Cl. 439/367

(57) ABSTRACT

A receptacle connector includes a main body and a cover. The main body includes a bottom wall, a front wall, a rear wall, a first side wall, and a second side wall cooperatively defining a receiving space for receiving an electronic element. The cover a connecting portion, a latching portion, and a cover body. The connecting portion is pivotably connected to the rear wall of the main body. The latching portion is latchable with the front wall of the main body. The cover body is located between the connecting portion and the latching portion. The cover body includes a resisting portion bending towards the bottom wall, the resisting portion has a flat bottom surface facing towards the bottom wall. The flat bottom surface is substantially parallel to the bottom wall while the latching portion latching with the front wall of the main body.

### BACKGROUND

1. Technical Field

The present disclosure relates to receptacle connectors and, particularly, to a receptacle connector capable of preventing a plug connector received therein moving relative to the receptacle connector.

2. Description of Related Art

Receptacle connectors are commonly used in electronic devices such as network equipments and telephones. A conventional receptacle connector includes a main body and a number of terminals fixed in the main body. The main body defines a receiving space to receive a plug connector. However, because the size of the receiving space is usually larger than that of the plug connector, the plug connector can move relative to the main body of the conventional receptacle connector, accordingly, the stability of the connection between the receptacle connector and the plug connector is not great.

What is needed, therefore, is a receptacle connector capable of preventing a plug connector received therein moving relative to the receptacle connector to overcome or at least mitigate the above-described problem.

### BRIEF DESCRIPTION OF THE DRAWINGS

Many aspects of the present receptacle connector can be better understood with reference to the accompanying drawings. The components in the drawings are not necessarily drawn to scale, the emphasis instead being placed upon clearly illustrating the principle of the present receptacle connector. In the drawings, all the views are schematic.

FIG. 1 is a schematic exploded view of a receptacle connector according to an exemplary embodiment.

FIG. 2 is a schematic assembled view of the receptacle connector of FIG. 1.

FIG. 3 is a schematic view of the receptacle connector in use state.

### DETAILED DESCRIPTION

Embodiments of the present disclosure will now be described in detail below, with reference to the accompanying drawings.

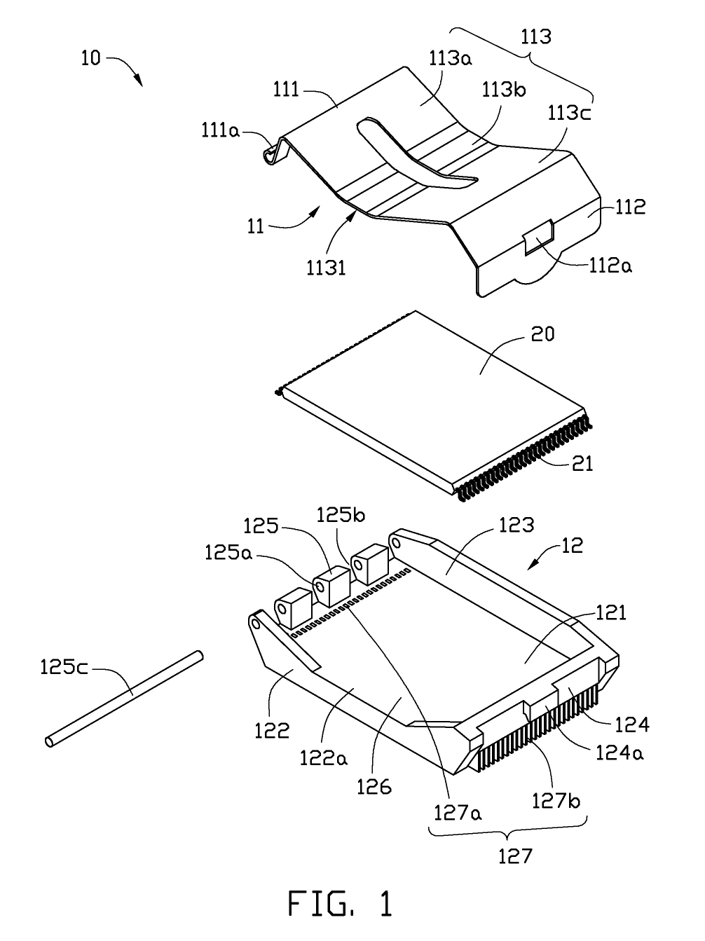

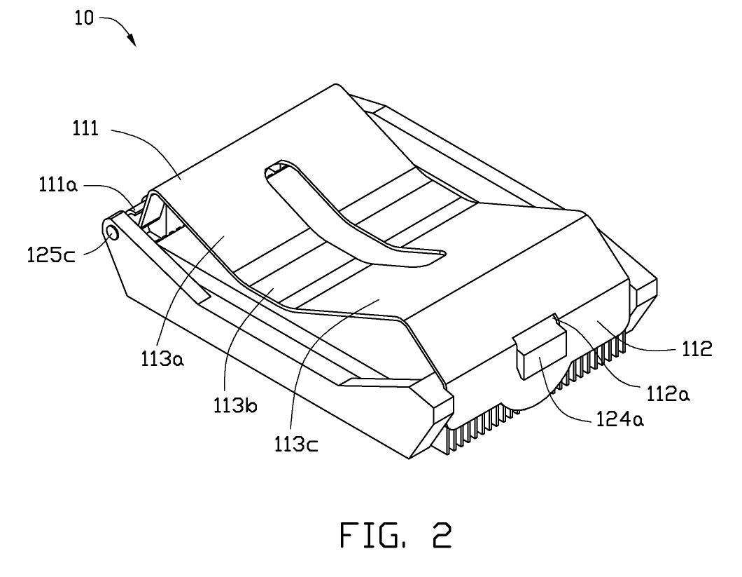

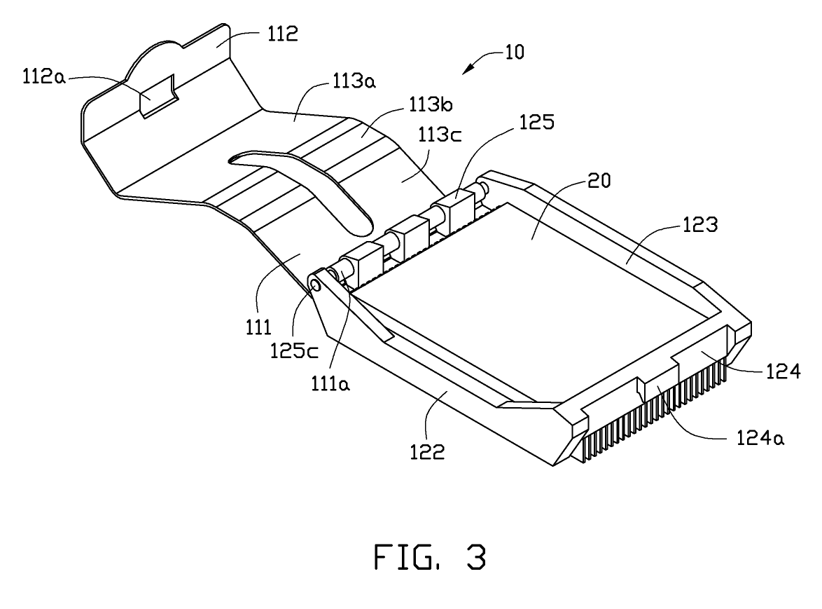

Referring to FIGS. 1 to 3, a receptacle connector 10 according to an exemplary embodiment, is shown. The receptacle connector 10 includes a cover 11 and a main body 12.

The main body 12 includes a bottom wall 121, a first side wall 122, a second side wall 123, a front wall 124, and rear wall 125, which cooperatively define a receiving space 126 to receive an electronic element 20 such as a chip or a plug connector.

In the present embodiment, the bottom wall 121 includes a number of signal terminals 127 formed thereon. Each signal terminal 127 includes a first end 127a formed on an inner surface of the bottom wall 121, and a second end 127b extending out of the main body 12. The first end 127a is configured to connect with the electronic element 20, and the second end 127b is configured to connect with another electronic component, such as a circuit board etc.

The first side wall 122 and the second side wall 123 are disposed at two opposite sides of the main body 12. In the present embodiment, the first side wall 122 further defines a cutout 122a communicating with the receiving space 126. Thus, the position of the electronic element 20 after being received in the receiving space 126 can be adjusted by a rod (not shown) etc. inserted into the receiving space 126 through the cutout 122a.

The front wall 124 includes a projection 124a formed on an outer surface of the front wall 124. The rear wall 125 defines a through hole 125a. The center axis of the through hole 125a is substantially parallel to the front wall 124, and is substantially perpendicular to the first side wall 122 and the second side wall 123. In the present embodiment, the rear wall 125 also defines a number of gaps 125b running through an inner surface and an outer surface of the rear wall 125. Thus, the position of the electronic element 20 after being received in the receiving space 126 can be adjusted by a rod (not shown) etc. inserted into the receiving space 126 through the gaps 125b. The rear wall 125 further includes a pivot 125c inserted into the through hole 125a.

The cover 11 includes a connecting portion 111, a latching portion 112, and a cover body 113.

The connecting portion 111 and the latching portion 112 are located at two opposite ends of the cover body 113. The connecting portion 111 is pivotably connected to the rear wall 125 of the main body 12. In the present embodiment, the connecting portion 111 includes a number of hooks 111a hooked to the pivot 125c. The latching portion 112 is bendable relative to the cover body 113. The latching portion 112 defines a latching hole 112a for latching with the projection 124a of the front wall 124.

The cover body 113 is made of elastic material and is substantially arc-shaped with the center thereof bending towards the bottom wall 121 of the main body. The cover body 113 includes a first extending portion 113a, a resisting portion 113b, and a second extending portion 113c. The resisting portion 113b is located in the center of the cover body 113. The first extending portion 113a connects the connecting portion 111 to the resisting portion 113b, and the second extending portion 113c connects the latching portion 112 to the resisting portion 113b. The resisting portion 113b has a flat bottom surface 113l facing the bottom wall 121 of the main body 12. The flat bottom surface 113l of the resisting portion 113b is substantially parallel to the bottom wall 121, while the latching portion 112 latches with the front wall 124 of the main body 12. Thus, the flat bottom surface 113l can increase the contact area between the cover body 113 and the electronic element 20, and the friction between the cover body 113 and the electronic element 20 increases.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

1. A receptacle connector comprising:
a main body comprising a bottom wall, a front wall, a rear wall, a first side wall, and a second side wall, the bottom wall, the front wall, the rear wall, the first side wall, and the second side wall cooperatively defining a receiving space for receiving an electronic element; and
a cover comprising:
a connecting portion pivotably connected to the rear wall of the main body;
a latching portion for latching with the front wall of the main body; and
a cover body located between the connecting portion and the latching portion, the cover body comprising a resisting portion bending towards the bottom wall of the main body, the resisting portion comprising a flat bottom surface facing towards the bottom wall, the flat bottom surface being substantially parallel to the bottom wall while the latching portion latching with the front wall of the main body,
wherein the front wall comprises a projection formed on an outer surface thereof, the latching portion of the cover defines a latching hole corresponding to the projection on the front wall, the latching portion of the cover is bendable relative to the cover body of the cover, and the first side wall defines a cutout communicating with the receiving space.

2-9. (canceled)

10. A receptacle connector comprising:
a main body comprising a bottom wall, a front wall, and a rear wall, the bottom wall, the front wall, and the rear wall cooperatively defining a receiving space for receiving an electronic element; and
a cover comprising:
a connecting portion pivotably connected to the rear wall of the main body;
a latching portion for latching with the front wall of the main body; and
a cover body located between the connecting portion and the latching portion, the cover body comprising a resisting portion bending towards the bottom wall of the main body, the resisting portion comprising a flat bottom surface facing towards the bottom wall, the flat bottom surface being substantially parallel to the bottom wall while the latching portion latching with the front wall of the main body,
wherein the front wall comprises a projection formed on an outer surface thereof, the latching portion of the cover defines a latching hole corresponding to the projection on the front wall, the latching portion of the cover is bendable relative to the cover body of the cover, and a side wall of the receiving space defines a cutout communicating with the receiving space.

11-18. (canceled)
